(19) United States
(12) Patent Application Publication
(10) Pub. No.: US 2001/0002955 A1
(43) Pub. Date: Jun. 7, 2001

(54) Image forming apparatus

(76) Inventor: Masamichi Kimura, Niigata (JP)

Correspondence Address: YOUNG & THOMPSON, 745 SOUTH 23RD STREET 2ND FLOOR, ARLINGTON, VA, 22202

(21) Appl. No.: 09/727,674

(22) Filed: Dec. 4, 2000

(30) Foreign Application Priority Data
Dec. 2, 1999 (JP) 342709/1999

(51) Int. Cl. G03G 15/16

(52) U.S. Cl. 399/296; 399/307

(57) ABSTRACT

An optical photoreceptor belt is rotated by a pair of belt drive rollers. The belt is positively charged by a main-charger. Latent images having a low electric potential are formed on the belt by exposing the positively charged belt by laser diode units, In developer units, ink having positive electric charge is moved by electrostatic force from develop rollers having a high electric potential to spots of the latent images on the belt having a low electric potential to form the images. The optical photoreceptor belt with images formed thereon passes through a dying unit and is recharged by a sub-charger. The images are transferred onto a transfer roller applied a negative voltage and then transferred onto the paper when a paper passes through between a transfer roller and a fixing roller.

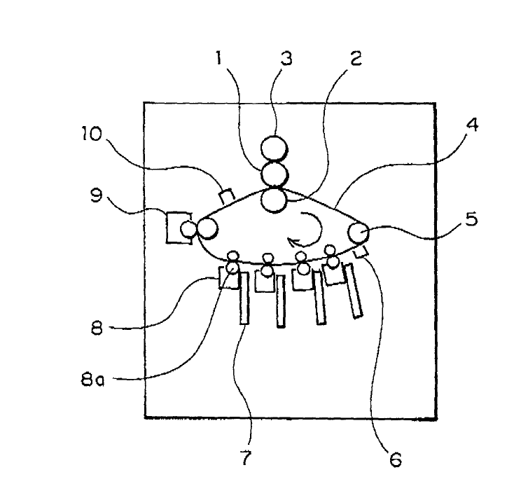

### BACKGROUND OF THE INVENTION

This invention relates to an image forming apparatus for use in a printer, a copying machine, a facsimile or the like and, in particular, to the image forming apparatus in which an efficiency upon transferring toner is improved by making toner easily movable on a transfer roller.

In recent years, fine and beautiful images such as graphics or photographs are required in a varieties of image forming apparatus. In order to meet the requirement, images composed of a number of fine dots and formed on an optical photoreceptor belt must exactly be transferred to a printing medium such as a paper. In the conventional image forming apparatus, the images have been transferred from the optical photoreceptor belt to the transfer roller by relying upon the adhesive force of the toner produced by subjecting toner to the heat and the pressure at a transfer portion.

However, the above-mentioned conventional image forming apparatus has a problem as described hereinbelow. Namely, not all the dots, particularly the fine dots, will be transferred onto the transfer roller since the fine dots tend to remain on the optical photoreceptor belt. The images thus produced will have empty spots those corresponding to the dots remained on the optical photoreceptor belt.

### SUMMARY OF THE INVENTION

Accordingly, it is an object of this invention to provide an image forming apparatus which improves printed images by raising an efficiency in transferring images from an optical photoreceptor belt to a transfer roller.

In accordance with an aspect of this invention, there is provided an image forming apparatus comprising: a transfer roller for transferring images onto a paper; a belt for transferring the images formed of toner onto the transfer roller; a main-charger for charging the belt positively; a laser diode unit for making latent images by exposing the positively charged belt; a developer unit for convening the latent images into the images; and a sub-charger for recharging the belt which is positioned between the developer unit and the transfer roller, thereby the efficiency upon transferring the images from the belt to the transfer roller will be improved by electrostatic force.

### BRIEF DESCRIPTION OF THE DRAWING

FIGURE is an outline view of the whole structure of an image forming apparatus according to an embodiment of this invention.

### DESCRIPTION OF THE PREFERRED EMBODIMENT

At first, description will be made about an essential point of an image forming apparatus according to an embodiment of this invention.

A transfer roller 1 is disposed on an optical photoreceptor belt 4. The transfer roller 1 transfers images formed by toner onto a print medium (such as a paper, not shown). The images formed on the optical photoreceptor belt 4 are transferred to the transfer roller 1. Then the images formed on the transfer roller 1 are transferred onto the paper. The transfer roller 1 also serves to fix the images. The transfer roller 1 and a fixing roller 3 are heated by a proper means. The transfer roller 1 is kept in contact with both a transfer backup roller 2 and the fixing roller 3. The paper is introduced between the transfer roller 1 and the fixing roller 3 from the right-hand side toward the left-hand side as illustrated in the FIGURE. The medium on which the images are printed is thus obtained. The image forming apparatus equipped with a main-charger 6 for charging the optical photoreceptor belt 4 is characterized by a sub-charger 10 for recharging the optical photoreceptor belt 4 additionally provided thereto and, in a process of transferring the images from the optical photoreceptor belt 4 onto the transfer roller 1, the image forming apparatus transfers the images by means of adhesive force, generated by heat of both the transfer roller 1 and the fixing roller 3 and by pressure among the rollers 1, 2, and 3, and by means of electrostatic force to stick the toner to the transfer roller 1.

In particular, since the adhesive force of the toner of the images such as half-tone dots is smaller than that of large solids, the images having half-tone dots or the like are difficult to be completely transferred. On the other hand, since carrier components in ink which form the images having fine dots, such as half-tone dots, have tendency to remain more than that of the large solids, the images having half-tone dots or the like may have an electric charge. Consequently, the images having fine dots may be effectively transferred by the electrostatic force.

Accordingly, when transferring the images having the fine dots such as half-tone dots from the optical photoreceptor belt 4 to the transfer roller 1, it is possible to reduce the amount of toner to be remained on the optical photoreceptor belt 4 without being transferred. In short, the image forming apparatus can raise the efficiency of transferring the fine patterns having fine dots, such as half-tone dots.

Next, description will proceed in detail to the image forming apparatus according to the embodiment of this invention.

In the embodiment, the optical photoreceptor belt 4 is disposed at the center of the image forming apparatus, The main-charger 6 for charging the optical photoreceptor belt 4 and four developer units 8 for forming the images are disposed at the lower part of the image forming apparatus. Each of the developer units 8 has a developer roller 8a. Further, four laser diode units 7 are disposed in front of each of the developer units 8, respectively. A drying unit 9 is disposed at a downstream spot from the developer units 8 and the laser diode units 7. The sub-charger 10 for recharging the optical photoreceptor belt 4 is disposed at a downstream spot from the drying unit 9, Three rollers, namely, the transfer roller 1, the transfer backup roller 2, and the fixing roller 3 are disposed at a downstream spot of the sub-charger 10. A surface of the transfer roller I is made of conductive material so that a high voltage can be applied to the transfer roller 1.

Description proceeds to an operation of the image forming apparatus according to the embodiment of this invention. Firstly, the optical photoreceptor belt 4 rotates in the direction as illustrated by an arrow in the FIGURE by a pair of belt drive rollers 5. After a surface of the optical photoreceptor belt 4 is positively charged, latent images with the electric potential which is lowered by the exposure from the laser diode units 7 are formed on the optical photoreceptor belt 4.

Next, in the developer units 8, ink having positive electric charge is moved from the developer roller 8a having a high electric potential to the latent images having a low electric potential on the optical photoreceptor belt 4 by electrostatic force to produce the images on the optical photoreceptor belt 4. The optical photoreceptor belt with images formed thereon are passed through the drying unit 9 and is recharged by the sub-charger 10. Further, the images on the optical photoreceptor belt 4 are transferred onto the transfer roller 1 with a negative voltage applied thereto. Furthermore, when a paper passes between the transfer roller 1 and the fixing roller 3, the images are transferred and fixed onto the paper. Finally, the paper is discharged from the image forming apparatus, and thus the printed medium is obtained.

The image forming apparatus according to this invention uniquely serves to apply a potential difference in order to transfer the toner with ease. For this purpose, the sub-charger 10 which is disposed between the drying unit 9 and the transfer roller 1 charges the optical photoreceptor belt 4 positively. The image on the optical photoreceptor belt 4 is positively charged after passing through the drying unit 9. At the transfer roller 1 to which the negative voltage is applied, the toner can move with ease from a portion having a high electric potential to the portion having a low electric potential, that is to say, from the optical photoreceptor belt 4 to the transfer roller 1. As a result, the efficiency in transferring the images can be improved in the image forming apparatus.

As described above, in the conventional image forming apparatus, the images on the optical photoreceptor belt were used to be transferred onto the transfer roller by the means of the adhesive force of toner obtained by heating and applying pressure to the toner at the transfer portion. According to the present invention, in addition to the above-described conventional means, the image forming apparatus has an advantageous effect as follows. The toner having the positive electric charge is attracted to the transfer roller by the potential difference because the negative voltage is applied to the transfer roller. In other words, the toner is moved to the transfer roller by the electrostatic force.

The efficiency of transferring the toner is lowered for the images having the fine patterns because the adhesive force of the toner used in the fine patterns having the fine dots, such as the half-tone dots, is smaller than that of the large solid patterns, However, in the image forming apparatus according to this invention, since the carrier components in the ink of the fine patterns have tendency to be remained as compared with the large solid patterns, the fine patterns may have the electric charge to be easily transferred. Accordingly, the efficiency in transferring the fine patterns is improved.

What is claimed is:

1. An image forming device comprising: a transfer roller for transferring images onto a paper; a belt for transferring said images formed by toner onto said transfer roller; a main-charger for charging said belt positively; a laser diode unit for making latent images by exposing said positively charged belt; a developer unit for converting said latent images into said images; and a sub-charger for recharging said belt and disposed between said developer unit and said transfer roller, thereby efficiency for transferring said images from said belt to said transfer roller rises by electrostatic force.

2. An image forming device as claimed in claim 1, wherein said sub-charger charges said belt positively.

3. An image forming device as claimed in claim 2, wherein said transfer roller is applied with a negative voltage.

4. An image forming device as claimed in claim 3, wherein a drying unit for drying said belt is disposed between said developer unit and said sub-charger.

5. An image forming device as claimed in claim 4, wherein said belt is an optical photoreceptor.

6. An image forming device as claimed in claim 5, wherein said belt is disposed between said transfer roller and a transfer backup roller, and said paper is put between said transfer roller and a fixing roller.
